(19) United States
(12) Patent Application Publication
(10) Pub. No.: US 2008/0143282 A1
(43) Pub. Date: Jun. 19, 2008

(54) Inductive sense spindle start algorithm

(75) Inventor: Eugene F. Plutowski, Rochester, MN (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/642,252

(22) Filed: Dec. 19, 2006

(51) Int. Cl. H02P 7/00

(52) U.S. Cl. 318/268

(57) ABSTRACT

A control circuit for a hard drive or sensorless DC spindle motor is provided. The control circuit includes a spindle driver generating a spindle motor control output. A spindle controller coupled to the spindle driver causes the spindle driver to vary the spindle motor control output during an inductive sense operation. An inductive sense system coupled to the spindle controller controls the operation of the inductive sense system, such as to turn the inductive sense system on when the spindle driver is off.

### FIELD OF THE INVENTION

The present invention relates to hard disk drive (HDD) controllers and brushless/sensorless DC motors, and more particularly to an improved inductive sense spindle start algorithm for brushless/sensorless DC motors.

### BACKGROUND OF THE INVENTION

When a sensorless DC spindle motor for a hard drive is started, it can experience backward spin or “backjogging.” Backjogging can cause damage over time to fluid bearings and can also result in the failure of the motor to start. Most inductive sense routines perform an inductive sense measurement and then drive the motor at a specified start current for a fixed period, which can result in backjogging.

### SUMMARY OF INVENTION

The present invention achieves technical advantages as a spindle drive motor controller start algorithm that increases then decreases a spindle driver output to reduce or eliminate spindle motor backjogging during start-up. The initial increasing of the drive torque allows the spindle drive to synchronize to the spindle mechanical movement. The later decreasing of the spindle drive allows the motor to be spun up to a higher RPM prior to entering run mode acceleration.

### BRIEF DESCRIPTION OF THE SEVERAL VIEWS OF THE DRAWINGS

FIG. 1 is a diagram of a system for controlling a hard drive spindle motor in accordance with an exemplary embodiment of the present invention;

FIG. 2 is a diagram of a timing cycle in accordance with an exemplary embodiment of the present invention; and

FIG. 3 is a diagram of a method for controlling a spindle driver in accordance with an exemplary embodiment of the present invention.

### DETAILED DESCRIPTION OF THE PRESENT INVENTION

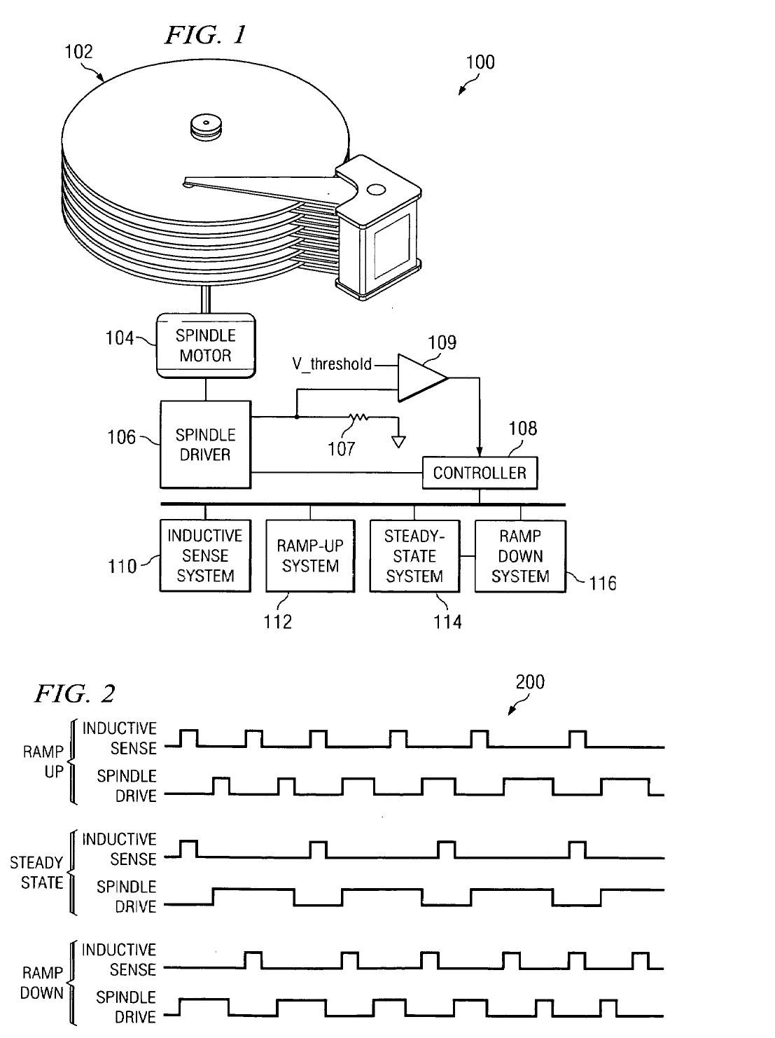

FIG. 1 is a diagram of a system 100 for controlling a hard drive spindle motor in accordance with an exemplary embodiment of the present invention. System 100 uses an improved inductive sense spindle start algorithm to prevent or reduce backjogging of the spindle motor.

System 100 includes magnetic media disc or a motor inertial mass 102 which is coupled to spindle motor 104, such as through a common rotor, a coupling between two rotors, or in other suitable manners. Spindle driver 106 is coupled to spindle motor 104 and outputs spindle motor control power, such as time varying spindle motor control power for a three-phase spindle motor that causes spindle motor 104 to rotate. Spindle driver 106 is coupled to controller 108, which generates control data that causes spindle driver 106 to generate the spindle motor 104 driving current having predetermined timing and magnitude characteristics. As used herein, the term “couple” and its cognate terms such as “coupled” and “couples” can include a physical connection (such as a shaft coupling or electrical conductor), a virtual connection (such as through one or more randomly assigned memory locations of a data processing systems), a logical connection (such as through one or more logical devices), or other suitable connections or combinations of connections.

Controller 108 is coupled to inductive sense system 110, ramp-up system 112, steady state system 114, and ramp-down system 116, each of which can be implemented in hardware, software, or a suitable combination of hardware and software, and which can be one or more software systems operating on a suitable processor, such as a digital signal processor. As used herein, a hardware system can include discrete semiconductor devices, an application-specific integrated circuit, a field programmable gate array, a general purpose processing platform, or other suitable devices. A software system can include one or more objects, agents, threads, lines of code, subroutines, separate software applications, user-readable (source) code, machine-readable (object) code, two or more lines of code in two or more corresponding software applications, databases, or other suitable software architectures. In one exemplary embodiment, a software system can include one or more lines of code in a general purpose software application, such as an operating system, and one or more lines of code in a specific purpose software application.

Inductive sense system 110 uses voltage comparator 109 to measure the peak current energized in a spindle motor through a sense resistor 107. Other suitable processes can also or alternatively be used, such as by sensing the current using sense FETs. The time from when the current flow in the motor phase is energized until the time when the comparator trips after reaching a programmed level of current (stated as V_threshold on comparator 109) is then determined. In one exemplary embodiment, this time measurement function can be performed using controller 108. This time period is measured initially on all commutation states to find the proper first commutation state to start spinning the motor. The shortest period measurement identifies which commutation state had the lowest inductance, which correlates to the lowest torque position of the motor. In one exemplary embodiment, initiation of the motor drive occurs at two commutation states forward from the lowest torque position of the motor to get maximum forward driving torque. After the first measurements are performed, subsequent inductive sense measurements can be performed to measure all or part of the commutation state inductive sense periods to determine whether the commutation state needs to be advanced to the next state. The overall sequence is to sense which commutation state to energize, then drive that phase for a period of time, then repeat the process until the motor is spinning fast enough to hand off commutation control to the hardware controlled commutation.

Ramp-up system 112 generates ramp-up/increasing inductive sense drive time data that is used by controller 108 to control spindle driver 106 during a ramp-up period of operation. In one exemplary embodiment, ramp-up system 112 generates an increasing period for operation of spindle driver 106 during which inductive sense measurements are taken by inductive sense system 110. In this exemplary embodiment, the length of time can be varied between predetermined minimum and maximum time periods, and can be discretely varied over a predetermined period of time by a number of predetermined of steps. Inductive sense system 110 can operate during periods when the output of ramp-up system 112 is used to turn spindle motor 104 off.

Steady state system 114 generates a steady state constant inductive sense drive time spindle driver control output that is used by controller 108 to control spindle driver 106 during a steady state period of operation. In one exemplary embodiment, steady state system 114 output allows controller 108 to control the operation of spindle driver 106 so that it alternately causes spindle motor 104 to turn on for a predetermined period of time that does not change over the steady state period, and to then turn off during a period of time when inductive sense system 110 is operating.

Ramp-down system 116 generates ramp-down/decreasing inductive sense drive time data that is used by controller 108 to control spindle driver 106 during a ramp-down period of operation. In one exemplary embodiment, ramp-down system 116 can decrease the period of operation for spindle driver 106 by a discrete amount over a predetermined period of time from a maximum to a minimum. Likewise, inductive sense system 110 can operate during periods when the output of ramp-down system 116 is used to turn spindle motor 104 off.

In operation, system 100 helps to reduce or eliminate motor backjogging or backwards rotation for a spindle drive motor. Such backwards movement can cause the motor to fail and can cause damage to and eventual failure of fluid bearings. In addition, decreasing the drive time after the motor starts to accelerate allows spindle motor 104 to be accelerated to a higher RPM prior to the time when control of spindle motor is taken over by open loop acceleration control. Such higher RPM allows phase detectors to be used to monitor the motor back EMF (BEMF) voltage. At very low RPM, the BEMF of the motor is too low to trip the comparators, which is why start algorithms are used to accelerate the motor speed high enough for the phase comparators to monitor the BEMF for hand-off to open loop acceleration control.

Prior art inductive sense routines perform inductive sense measurements and drive the spindle motor at a predetermined start current for a fixed period of time. Ramping the drive time during the initial movement of the motor stops it from backjogging, and then decreasing the drive time after the motor starts accelerating allows the algorithm to commutate the motor to a higher RPM.

FIG. 2 is a diagram of a timing cycle 200 in accordance with an exemplary embodiment of the present invention. Timing cycle 200 can be generated by a spindle driver controller or other suitable systems.

In the first timing sequence of timing cycle 200, a ramp-up period is shown where an inductive sense timing signal alternates between a spindle drive timing single. The spindle drive timing signal alternates from off to on, and is used to turn the spindle motor on when the inductive sense is off. Likewise, the inductive sense timing signal alternates from off to on, and is used to turn the inductive sense circuit off when the spindle motor drive is on. During the ramp-up period, the spindle drive signal timing “on” period increases, as shown for example, from one cycles, to two cycles, to three cycles.

After ramp-up, the system enters a steady state mode of operation, such as where the hard drive spindle motor receives a repeated alternating drive current cycle having a fixed “on” and “off” period. As shown, inductive sense signals are generated at a periodic interval when the spindle motor drive signal is “off.”

During a ramp-down period, the inductive sense control signal and spindle drive control signal continue to operate during alternating periods, but the spindle drive control signal duration decreases. In the exemplary embodiment shown, the spindle drive decreases for example from three periods to two periods to one period of operation during ramp-down.

In operation, the spindle drive controller output shown in FIG. 2 is used to generate spindle motor controls and inductive sense controls for a hard drive. The timing diagram of system 200 allows a spindle driver to be controlled so as to prevent spindle backjogging.

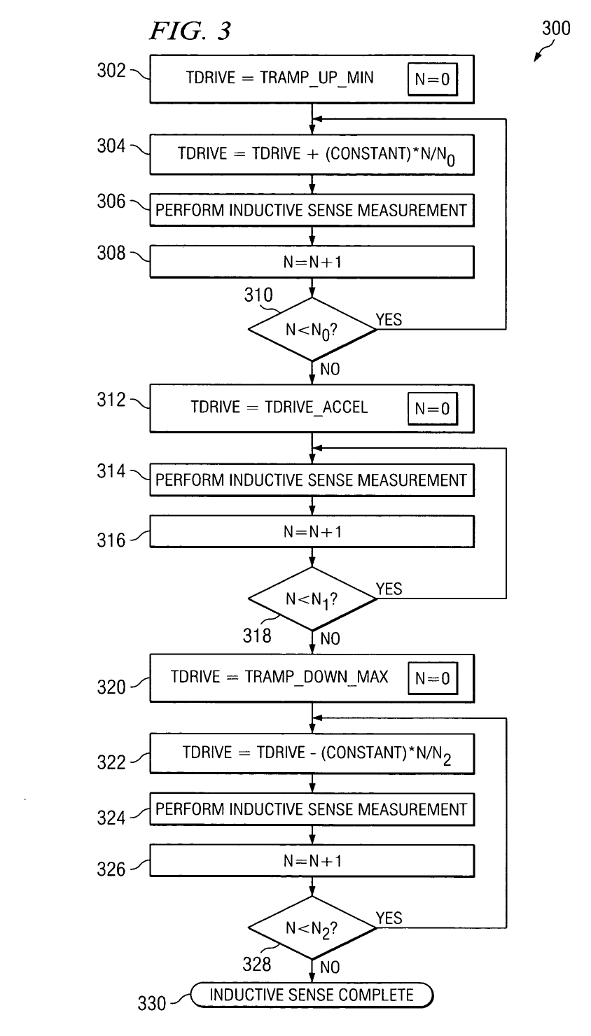

FIG. 3 is a diagram of a method 300 for controlling a spindle driver in accordance with an exemplary embodiment of the present invention. Method 300 begins at 302 where a spindle motor drive period is set equal to a minimum ramp-up drive period. In addition, a counter such as “N” can be set to zero and a second variable such as “N₀” can be set to equal the number of periods over which to ramp-up or increase the spindle motor drive period. The method then proceeds to 304. At 304, the spindle motor drive period is set equal to the previous value of the spindle motor drive period plus a constant times the current value of the counter divided by the constant value “N₀.” Likewise, other suitable processes can be used, such as setting the spindle motor drive period based on how fast the motor is spinning. The method then proceeds to 306.

At 306, an inductive sense measurement is taken, such as by using an inductive sense measurement system. The method then proceeds to 308 where the value of the counter “N” is increased by one, and the method proceeds to 310. At 310, it is determined whether the number of steps taken, as represented by the counter “N,” has exceeded the number of periods over which to ramp-up or increase the spindle motor speed, as represented by the variable “N₀.” If “N” does not exceed “N₀” then the method returns to 304. Otherwise the method proceeds to 312.

At 312, the spindle motor drive period is set equal to a constant value. In addition, the iteration counter “N” can be set to zero and a constant such as “N₁” can be set to equal to the number of periods during which the spindle motor drive period is to be held constant. Likewise, other suitable processes can be used, such as holding the spindle motor drive period constant during a period based on how fast the motor is spinning. The method then proceeds to 314.

At 314, inductive sense measurements are performed. The method then proceeds to 316 where the counter “N” is incremented by one. The method then proceeds to 318 where it is determined whether the counter “N” has exceeded the constant “N₁,” or where other suitable processes are used to determine whether the number of periods during which the spindle motor drive period is to be held constant has been reached. If it is determined that “N” exceeds “N₁,” the method returns to 314 otherwise the method proceeds to 320.

At 320, the spindle motor drive period is set to a predetermined value. The counter “N” can be reset to zero and a constant such as “N₂” can be set to equal to the number of periods during which the spindle motor drive period is to be decreased. Likewise, other suitable processes can be used, such as decreasing the spindle motor drive period during a period based on how fast the motor is spinning. The method then proceeds to 322 where the spindle motor drive period is set equal to the previous spindle motor drive period minus a constant times the current value of the counter “N” divided by the value of the constant “N₂.” The method then proceeds to 324 where an inductive sense measurement is performed, and the method then proceeds to 326.

At 326, the counter “N” is incremented by one. The method then proceeds to 328 where it is determined whether the value of the counter “N” has exceeded “N₂,” the number of periods during which the spindle motor drive period is to be decreased. If it is determined at 328 that “N” has exceeded “N₂,” the method returns to 322, otherwise the method proceeds to 330 where the inductive sense process is completed. Likewise, a run or acceleration mode can be entered or other suitable processes can be initiated.

In operation, method 300 allows the spindle motor drive period to be ramped-up so as to reduce or eliminate motor backjogging, held in steady state, and ramped-down to allow the motor to be accelerated to a higher RPM.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A control circuit for a hard drive spindle motor comprising:
a spindle driver configured to generate a spindle motor control output;
a spindle controller coupled to the spindle driver and configured to cause the spindle driver to vary a period of operation of the spindle motor control output; and
an inductive sense system coupled to the spindle controller, the spindle controller configured to control the operation of the inductive sense system.

2. The control circuit of claim 1 wherein the spindle controller is a software system operating on a processor.

3. The control circuit of claim 1 further comprising a ramp-up system coupled to the spindle controller and configured to generate an increasing period spindle motor drive signal.

4. The control circuit of claim 1 further comprising a steady-state system coupled to the spindle controller and configured to generate a constant period spindle motor drive signal after a ramp-up period.

5. The control circuit of claim 1 further comprising a ramp-down system coupled to the spindle controller and configured to generate a decreasing period spindle motor drive signal.

6. The control circuit of claim 1 wherein the inductive sense system is configured to generate an inductive sense control when there is no spindle motor drive signal being generated.

7. A method for controlling a hard drive spindle motor comprising:
increasing a duration of an operation period of a spindle motor during a first period while generating inductive sense measurements; and
maintaining the duration of the operation period of the spindle motor during a second period while generating the inductive sense measurements.

8. The method of claim 7 further comprising decreasing the duration of the operation period of the spindle motor during a third period while generating the inductive sense measurements

9. The method of claim 7 wherein increasing the duration of the operation period of the spindle motor during the first period while generating the inductive sense measurements comprises generating the inductive sense measurements in between operation periods of the spindle motor.

10. The method of claim 8 wherein decreasing the duration of the operation period of the spindle motor during the third period while generating the inductive sense measurements comprises generating the inductive sense measurements in between operation periods of the spindle motor.

11. The method of claim 7 wherein increasing the duration of the operation period of the spindle motor during the first period while generating the inductive sense measurements comprises increasing the duration of the operation period by a discrete amount.

12. The method of claim 8 wherein decreasing the duration of the operation period of the spindle motor during the third period while generating the inductive sense measurements comprises decreasing the duration of the operation period by a discrete amount.

13. A hard drive spindle motor controller comprising:
an inductive sense control output configured to alternate between on and off;
a spindle motor drive ramp-up control output configured to alternate between on and off, where a duration of an on period increases from a minimum to a maximum; and
wherein the inductive sense control output is configured to be on when the spindle motor drive ramp-up control output is off.

14. The hard drive spindle motor controller of claim 13 further comprising:
a spindle motor drive ramp-down control output configured to alternate between on and off, where a duration of an on period decreases from a maximum to a minimum; and
wherein the inductive sense control output is configured to be on when the spindle motor drive ramp-down control output is off.

15. The hard drive spindle motor controller of claim 13 wherein a duration of an on period of the inductive sense control output is configured to be constant.

16. The hard drive spindle motor controller of claim 13 further comprising:
a spindle motor drive steady-state control output configured to alternate between on and off, where a duration of an on period is constant; and
wherein the inductive sense control output is configured to be on when the spindle motor drive steady-state control output is off.
